(19) United States
(12) Patent Application Publication
(10) Pub. No.: US 2008/0239921 A1
(43) Pub. Date: Oct. 2, 2008

(54) OPTICAL INFORMATION RECORDING MEDIUM, OPTICAL INFORMATION RECORDING AND REPRODUCING APPARATUS, AND POSITION CONTROL METHOD

(75) Inventors: Shinichi Tatsuta, Tokyo (JP); Yuichiro Yamamoto, Tokyo (JP); Yuji Kubota, Kanagawa (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/026,672

(22) Filed: Feb. 6, 2008

(30) Foreign Application Priority Data
Mar. 27, 2007 (JP) 2007-082617

(51) Int. Cl. G11B 7/00

(52) U.S. Cl. 369/103

(57) ABSTRACT

An optical information recording medium includes a recording layer in which information can be recorded as a hologram by using a phenomenon of interference between an information light beam and a reference light beam. The recording layer is sandwiched between substrates. A thin film layer that is laminated on the substrate on light output side. Openings are formed in the recording layer and those openings allow passage of the information light beam and the reference light beam.

### CROSS-REFERENCE TO RELATED APPLICATIONS

This application is based upon and claims the benefit of priority from the prior Japanese Patent Application No. 2007-082617, filed on Mar. 27, 2007; the entire contents of which are incorporated herein by reference.

### BACKGROUND OF THE INVENTION

1. Field of the Invention

The present invention relates to a technology for recording/reproducing optical information to/from a recording medium as a hologram.

2. Description of the Related Art

Various approaches have been taken to increase the recording density of optical information recording media such as compact disks (CD) or digital versatile disks (DVD). Examples of those approaches are generation of a laser light beam with a shorter wavelength, or widening a numerical aperture (NA) of an objective lens. However, it is difficult to increase the recording density with conventional technologies, and there is a need to develop other technology for improving the recording density.

One of those technologies is a technology for recording/reproducing optical information in a high-density optical disk (hereinafter, “holographic optical disk”), which is a volume recording medium, by using technique of holography. For example, a conventional technology is disclosed by H. J. Coufal et al., “Holographic Data Storage”, Springer, 2000. As disclosed in this document, to record information in a holographic optical disk, a laser light beam is modulated by using a spatial light modulator, such as a liquid crystal element or a digital micro-mirror device, thereby converting the laser beam into an information light beam and a reference light beam. Both the light beams, the information light beam and the reference light beam, are then projected onto the same position in the holographic optical disk. An optical interference pattern is generated due to interference between the information light beam and the reference light beam. This optical interference pattern is recorded as a hologram in the holographic optical disk.

To reproduce information recorded on the holographic optical disk, only the reference light beam is projected on the holographic optical disk.

When information is recorded in a DVD, a laser light beam is projected onto a surface of the DVD, and a recording mark is formed on the surface. On the other hand, when information is recorded in a holographic optical disk, a laser light beam is projected onto a position in an information recording layer, and information is recorded in the thickness direction of the information recording layer. Thus, information can be multiplex-recorded in the holographic optical disk. In this manner, information can be recorded in a volume, rather than a surface of the information recording medium. As a result, higher recording density can be achieved in the holographic optical disk as compared to the DVD.

Moreover, information is recorded in a DVD by using a recording mark that generally includes bit data (ON/OFF). However, when information is recorded in a holographic optical disk, an information light beam carrying a relatively large amount of information is modulated and recorded as an interference pattern in the holographic optical disk. A set of information to be recorded in the holographic optical disc is called page data that is a minimum unit for recording/reproducing information. The page data is a pattern of the information light beam to be recorded and is a two-dimensional bar-code of dots in black and white.

In the conventional technology disclosed by H. J. Coufal et al., the recording density of the holographic optical disk is increased by recording page data in the disk in a multiplexed manner. Specifically, a plurality of page data sets is multiplex-recorded in the thickness direction of the disk. The multiplex recording is performed by, for example, projecting laser light beams onto the same position from different angles, or projecting laser light beams at the same angle onto positions that are slightly shifted from each other.

For example, U.S. Pat. No. 5,483,365 discloses a conventional technology for recording information in a multiplexed manner by controlling relative positions or relative angles between a laser light beam and a holographic optical disk. When information is recorded by controlling the relative angle in addition to shifting a focus position of a laser light beam, the holographic optical disk is rotated with respect to a laser light beam for adjustment. Because it is not the laser light beam that is rotated for adjustment, there is no need to arrange a mechanism for moving an optical system, such as a lens, resulting in simplicity of a recording/reproducing apparatus.

JP-A 2003-178484 (KOKAI), 2004-265472 (KOKAI), and 2004-326897 (KOKAI) disclose conventional technologies for detecting and controlling a relative position between a holographic optical disk and a laser light beam while rotating the holographic optical disk with respect to the laser light beam. A plurality of servo pits is arranged in the holographic optical disk, and a light beam is projected onto the holographic optical disk. The servo pits reflect the light beam. By detecting the reflected light beam, it is possible to detect a relative position between a holographic optical disk and a laser light beam.

However, because the direction to which the light beam is reflected from a servo pit varies depending on a relative angle between the light beam and the holographic optical disk, it is difficult to detect the reflected light beam. As a result, a relative position or a relative angle between a laser light beam and a holographic optical disk can hardly be controlled accurately.

### SUMMARY OF THE INVENTION

According to one aspect of the present invention, there is provided an optical information recording medium includes a substrate; a recording layer that is laminated on a first surface of the substrate, and in which information can be recorded as a hologram by using a phenomenon of interference between an information light beam and a reference light beam; and a thin film layer that is laminated on a second surface of the substrate, and that includes a first opening, wherein the first opening is arranged in a position onto which the information light beam and the reference light beam are projected, and allows passage of the information light beam and the reference light beam.

According to another aspect of the present invention, there is provided an apparatus for recording and reproducing optical information in an optical information recording medium. The apparatus includes a light source that emits a light beam; a spatial light modulator that receives the light beam and converts the light beam into an information light beam; a focusing unit that focuses the information light beam and a reference light beam onto the optical information recording medium, the optical information recording medium including a substrate; a recording layer that is laminated on a first surface of the substrate, and in which information can be recorded as a hologram by using a phenomenon of interference between the information light beam and the reference light beam; and a thin film layer that is laminated on a second surface of the substrate, and that includes a first opening, wherein the first opening is arranged in a position onto which the information light beam and the reference light beam are projected, and allows passage of the information light beam and the reference light beam; a detector that detects the information light beam and the reference light beam that have passed through the first opening in the thin film layer; a moving unit configured to move the optical information recording medium and the focusing unit relative to each other; and a position control unit that controls the moving unit to control a relative position of a focus position of the information light beam and the reference light beam and the optical information recording medium based on intensities of the information light beam and the reference light beam detected by the detector.

According to still another aspect of the present invention, there is provided a method of positioning realized in an apparatus for recording and reproducing optical information in an optical information recording medium. The method includes emitting a light beam; converting the light beam into an information light beam; focusing the information light beam and a reference light beam onto the optical information recording medium, the optical information recording medium including a substrate; a recording layer is laminated on a first surface of the substrate, and in which information can be recorded as a hologram by using a phenomenon of interference between the information light beam and the reference light beam; and a thin film layer that is laminated on a second surface of the substrate, and that includes a first opening, wherein the first opening is arranged in a position onto which the information light beam and the reference light beam are projected, and allows passage of the information light beam and the reference light beam; detecting the information light beam and the reference light beam that have passed through the opening in the thin film layer; and adjusting a relative position of a focus position of the information light beam and the reference light beam and the optical information recording medium based on intensities of the information light beam and the reference light beam detected at the detecting.

### BRIEF DESCRIPTION OF THE DRAWINGS

FIG. 1 is a cross sectional view of a holographic optical disk according to a first embodiment of the present invention;

FIG. 2 is a plan view of a surface of a thin film layer as shown in FIG. 1;

FIG. 3 is a schematic diagram of an optical system of a recording/reproducing apparatus according to the first embodiment;

FIG. 4 is a schematic diagram for explaining passage of an information light beam through a certain pinhole shown in FIG. 1;

FIG. 5 is a schematic diagram of a servomechanism of the recording/reproducing apparatus;

FIG. 6 is a graph for explaining a relation between intensity of the information light beam and a focus position of the information light beam in the holographic optical disk;

FIG. 7 is a flowchart of position control operation performed by the recording/reproducing apparatus upon recording information according to the first embodiment;

FIG. 8 is a flowchart of position control operation performed by the recording/reproducing apparatus upon reproducing information according to the first embodiment;

FIG. 9 is a schematic diagram of an optical system of a recording/reproducing apparatus according to a second embodiment of the present invention;

FIG. 10 is a schematic diagram of an optical system of a recording/reproducing apparatus according to a third embodiment of the present invention;

FIG. 11 is a schematic diagram for explaining passage of information light beam and servo light beams through a certain pinhole shown in FIG. 2;

FIG. 12 is a graph for explaining changes of intensities of the servo light beams due to positional deviation of a focus position of a laser light beam in the holographic optical disk;

FIG. 13 is a graph for explaining changes of intensities of the servo light beams due to positional deviation of a focus position of a laser light beam in the radial direction of the holographic optical disk;

FIG. 14 is a flowchart of position control operation performed by the recording/reproducing apparatus upon recording information according to the second embodiment;

FIG. 15 is a flowchart of position control operation performed by the recording/reproducing apparatus upon reproducing information according to the second embodiment;

FIG. 16 is a schematic diagram for explaining positions of three servo light beams projected onto a certain pinhole shown in FIG. 2;

FIG. 17 is a graph for explaining changes of intensities of the servo light beams due to positional deviation of the holographic optical disk in a direction X shown in FIG. 16;

FIG. 18 is a graph for explaining changes of intensities of the servo light beams due to positional deviation of the holographic optical disk in a direction Y shown in FIG. 16;

FIG. 19 is a schematic diagram for explaining positions of four servo light beams projected onto a certain pinhole shown in FIG. 2;

FIG. 20 is a graph for explaining changes of intensities of the servo light beams due to positional deviation of the holographic optical disk in a direction X shown in FIG. 19;

FIG. 21 is a graph for explaining changes of intensities of the servo light beams due to positional deviation of the holographic optical disk in a direction Y shown in FIG. 19; and

FIG. 22 is a schematic diagram for explaining passage of servo light beams through a pinhole.

### DETAILED DESCRIPTION OF THE INVENTION

Exemplary embodiments of the present invention are explained in detail below with reference to the accompanying drawings.

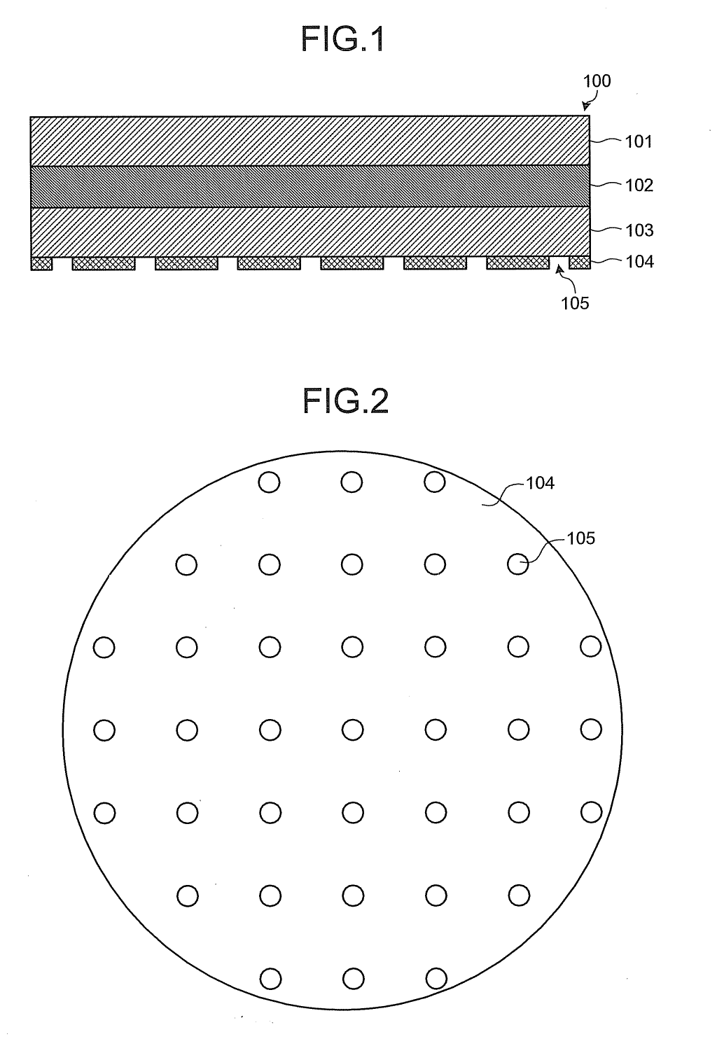

FIG. 1 is a schematic diagram of a holographic optical disk 100 as an optical information recording medium according to a first embodiment of the present invention. Information can be recorded in the holographic optical disk 100 as a hologram that is a pattern of bright and dark bands generated by a phenomenon of interference between an information light beam and a reference light beam.

The holographic optical disk 100 includes a hologram recording layer 102 sandwiched between two substrates 101, 103. A thin film layer 104 is laminated on the substrate 103. The thin film layer 104 has a plurality of openings 105 (hereinafter, “pinholes”). A laser light beam can pass through the pinholes 105 but can not pass through the thin film layer 104.

The substrates 101, 103 are made of a material having optical transparency, such as glass, polycarbonate, or acrylate resin, but not limited to such materials. The substrates 101, 103 are not necessarily made of a material that is transparent to a laser light beam having any wavelength, and can be made of a material that is transparent to a laser light beam having a wavelength to be used.

Information is recorded in the hologram recording layer 102 as a hologram by interference between an information light beam and a reference light beam (not shown). The hologram recording layer 102 can be made of a radical polymerizable material that is called a photopolymer that contains a radical polymerizable compound, a photo-radical polymerization initiator, a matrix material, and the like.

However, the material from which the hologram recording layer 102 can be made is not limited to such materials. In other words, the hologram recording layer 102 can be made of any material that allows hologram recording. The hologram recording layer 102 has a thickness of approximately several hundreds of micrometers to achieve sufficient diffraction efficiency for reproducing signals.

Recording a hologram in the hologram recording layer 102 is performed in the manner as explained below. An information light beam and a reference light beam are projected onto one position in the hologram recording layer 102 and superimposed with each other. As a result, an interference pattern is generated due to interference between the information light beam and the reference light beam. A photo-radical polymerization initiator contained in a photopolymer absorbs photons whereby it is activated. The activated photopolymer activates and promotes polymerization of monomers in bright bands of the interference pattern. When the polymerization of monomers proceeds and all the monomers are evaporated from the bright bands, monomers in dark bands of the interference pattern move toward the bright bands. As a result, the bright and dark bands with different densities are produced. In this manner, refractive-index modulation is generated in accordance with intensity distribution in the interference pattern, whereby a hologram is recorded in the hologram recording layer 102.

The thin film layer 104 is laminated on the light output side of the substrate 103. Many pinholes 105 are formed in the thin film layer 104. The information light beam and the reference light beam can pass only through the pinholes 105.

FIG. 2 is a plan view of the thin film layer 104. For convenience of explanation, only a few pinholes 105 are shown in FIG. 2; moreover, the pinholes 105 are shown enlarged. In other words, the number of the pinholes 105 is much more, and the size is much smaller than that shown in FIG. 2. The thin film layer 104, in which the pinholes 105 are arranged, is laminated on an area corresponding to the entire surface of the hologram recording layer 102. Each of the pinholes 105 is formed in a position corresponding to a recording area of the hologram recording layer 102.

A size of each of the pinholes 105 and a distance between the pinholes 105 are not limited to those shown in FIG. 2, and can be defined as appropriate depending on a recording method or an optical system to be used. However, it is preferable that the pinholes 105 have a circular shape as shown in FIG. 2. Assume that the pinhole 105 has a diameter D, and the pinholes 105 are arranged with a distance P between their centers. The diameter D needs to be larger than the diameter of the beam waist of the information light beam, and the distance P needs to be equal to a distance between adjacent recording areas of the hologram recording layer 102. Preferably, the diameter D and the distance P are defined by P>1.5×D.

The pinholes 105 can be formed by various methods. For example, an absorbing layer is first laminated by sputtering or the like, and the absorbing layer at certain positions is then etched to form the pinholes 105. Alternatively, the pinholes 105 are formed by applying an ink by printing.

The thin film layer 104 in regions other than where the pinholes 105 are formed is made of a light-absorbing material. The light-absorbing material absorbs a laser light beam thereby preventing the hologram recording layer 102 from being exposed to an undesired laser light beam that could be reflected from the thin film layer 104.

The thin film layer 104 is not necessarily laminated on an are corresponding to the entire surface of the hologram recording layer 102, and can be laminated on an area corresponding to a part of the surface of the hologram recording layer 102. Furthermore, the pinholes 105 are not necessarily formed in positions corresponding to all recording areas of the hologram recording layer 102.

Although the thin film layer 104 is shown to be laminated on the surface of the substrate 103, it is possible to embed the thin film layer 104 in the substrate 103.

Furthermore, the surface of the thin film layer 104 can be coated with a coating or a protective material having optical transparency.

The thin film layer 104 can be made of a photochromic material. When the thin film layer 104 is made of a photochromic material, it is possible to easily form a new pinhole by projecting a laser light beam onto a position in the thin film layer 104 corresponding to a recording area of the hologram recording layer 102.

The thin film layer 104 can be made of a liquid crystal or an electrochromic material. When the thin film layer 104 is made of a liquid crystal or an electrochromic material, the pinholes 105 can be formed only on a desired position in the thin film layer 104 at the time of recording and reproducing information. In addition, it is possible to prevent the hologram recording layer 102 from being exposed to an undesired laser light beam before operation of recording a hologram is started. Especially, because the pinholes 105 are formed on a desired position in the thin film layer 104 at the time of recording a hologram, it is possible to prevent the hologram recording layer 102 from being exposed to a so-called stray light beam. Furthermore, upon reproducing a hologram, it is possible to prevent crosstalk, i.e., prevent a reproduction light beam projected onto a desired recording area from being mixed with a reproduction light beam projected onto an adjacent recording area. Furthermore, the thin film layer 104 can be given a function of an information display device, such as a liquid crystal display monitor.

A recording/reproducing apparatus is employed to perform recording/reproducing with respect to the holographic optical disk 100. The recording/reproducing apparatus records a hologram in the hologram recording layer 102 of the holographic optical disk 100.

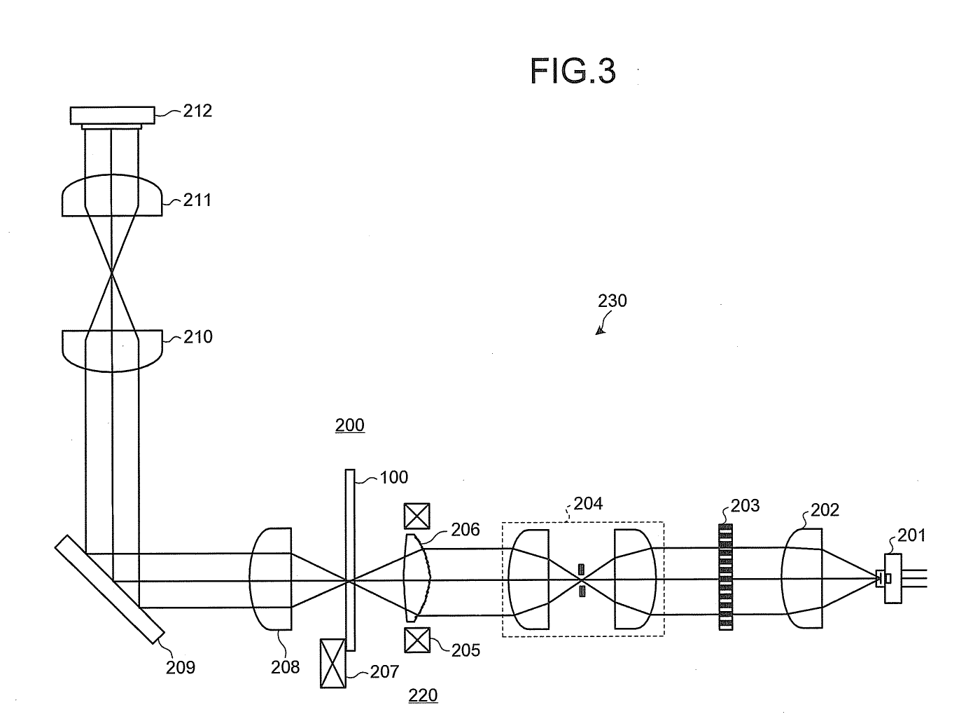

FIG. 3 is a schematic diagram of an optical system 200 and a portion of a servomechanism 220 of a recording/reproducing apparatus 230 according to the first embodiment. The optical system 200 includes a semiconductor laser 201, four collimator lenses 202, 208, 210, 211, a mirror 209, a spatial light modulator 203, a spatial filter 204, an objective lens 206, and a light detector 212. The servomechanism 220 includes an actuator 205 for moving the objective lens 206, and an actuator 207 for revolving the holographic optical disk 100. It can be configured that the actuator 207 or some other actuator (not shown) moves the holographic optical disk 100 from right to left or up and down, so that a relative position between the holographic optical disk 100 and a laser light beam can be controlled.

The semiconductor laser 201 emits a blue-violet laser light beam having a wavelength of about 405 nanometers for recording/reproducing information to/from the hologram recording layer 102. The semiconductor laser 201 emits a linearly-polarized laser light beam that is a divergent light beam, and the collimator lens 202 converts the divergent light beam into a parallel light beam. The parallel light beam enters the spatial light modulator 203. The spatial light modulator 203 modulates the intensity of the laser light beam thereby obtaining an information light beam and a reference light beam. The information light beam and the reference light beam are then output from the spatial light modulator 203. A liquid crystal element can be used as the spatial light modulator 203. Alternatively, a digital micro-mirror device or a ferroelectric liquid crystal with a high response speed, for instance, several tens of microseconds can be used as the spatial light modulator 203.

The information light beam carries binary pattern information (page data) that includes digitally-coded information to be recorded and an error-correction code embedded with the information to be recorded. An amount of data carried by the information light beam is about 10 to 20 kilobytes per frame. However, the amount of data to be carried depends on the number of pixels of the spatial light modulator 203 or an image pickup device (not shown) or an encoding method to be used. Although the embodiment assumes that information to be recoded includes binary values of “0” and “1”, information can be a multiple value, so that it is possible to increase an amount of data to be carried per frame.

The spatial filter 204 includes two lenses and an iris diaphragm. The spatial filter 204 receives the information light beam and the reference light beam from the spatial light modulator 203, and filters out an undesired high-order diffracted light beam contained in the information light beam and the reference light beam.

The objective lens 206 receives the information light beam and the reference light beam output from the spatial filter 204. The objective lens 206 converges the information light beam and the reference light beam onto the holographic optical disk 100.

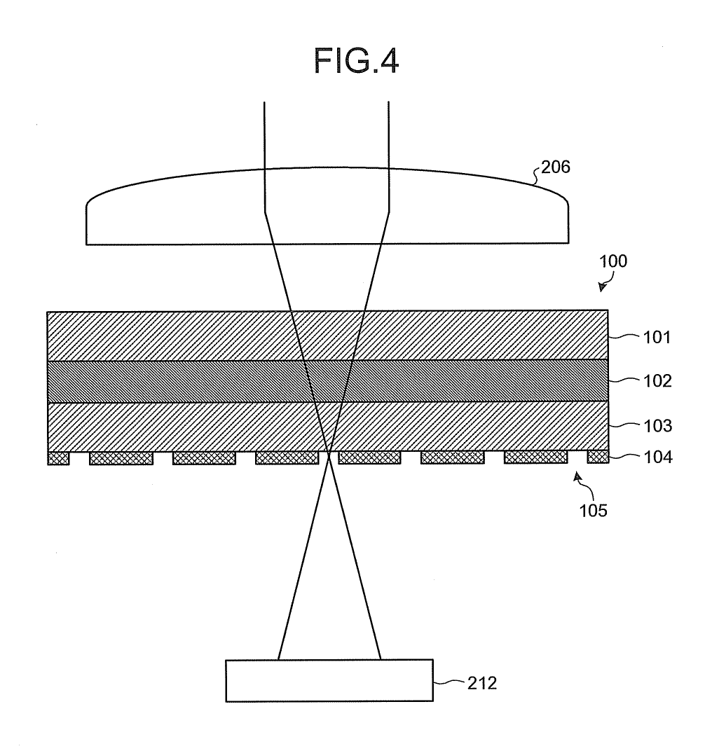

FIG. 4 is a schematic diagram for explaining passage of the information light beam through the pinholes 105. When the information light beam and the reference light beam are projected onto the holographic optical disk 100, the information light beam and the reference light beam pass through the pinholes 105. For convenience of explanation, the reference light beam and a part of the optical system 200 are not shown.

As shown in FIG. 3, the collimator lens 202 collects the information light beam and the reference light beam that pass through the pinholes 105 of the holographic optical disk 100. The collimator lens 202 converts the information light beam and the reference light beam into parallel light beams, and the mirror 209 then changes a traveling direction of the information light beam and the reference light beam by 90 degrees. The collimator lenses 210 and 211 receive and output the information light beam and the reference light beam, and then the light detector 212 receives the light beams as a two-dimensional image.

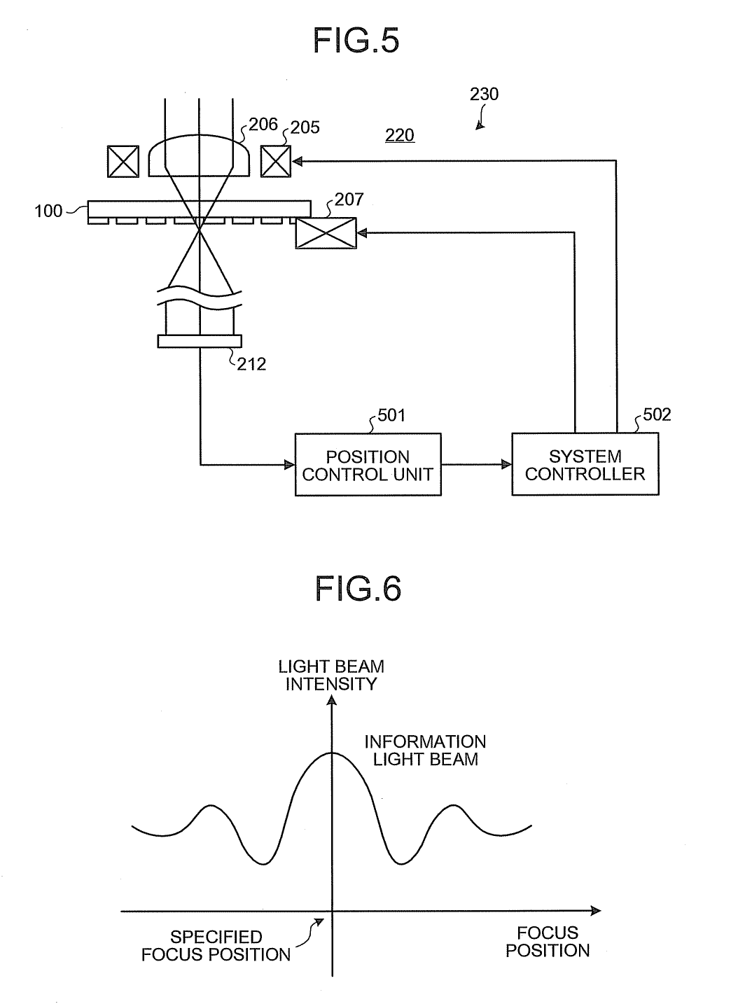

The light detector 212 converts information contained in the information light beam into electric signals, and then transmits the electric signals to a position control unit 501 in the servomechanism 220 (see FIG. 5). Based on intensity of the information light beam detected by the light detector 212, a relative position between a focus position of the laser light beam and the holographic optical disk 100 is controlled as appropriate. Such a position control operation will be described in detail later.

FIG. 5 is a schematic diagram of the servomechanism 220. The servomechanism 220 includes the actuator 205, the actuator 207, the position control unit 501, and a system controller 502.

The actuator 205 moves the objective lens 206 in a radial direction of the holographic optical disk 100, a track direction of the holographic optical disk 100 (a horizontal direction as shown in FIG. 1), and a direction perpendicular to the radial direction (a vertical direction as shown in FIG. 1) based on a command received from the system controller 502.

The system controller 502 controls the operation of the actuators 205, 207 based on a command received from the position control unit 501.

The position control unit 501 performs position control, i.e., controls a relative position and a relative angle between a laser light beam (an information light beam and a reference light beam) and the holographic optical disk 100 based on intensities of the information light beam and the reference light beam detected by the light detector 212. Specifically, the position control unit 501 determines a specified focus position of a laser light beam in such a manner that, when the intensities of the information light beam and the reference light beam detected by the light detector 212 become a maximum value, it is determined that the information light beam and the reference light beam are converged onto a specified focus position. The position control unit 501 sends a command to the system controller 502 to drive the actuator 205 or the actuator 207, so that the information light beam and the reference light beam are converged onto the specified focus position.

The information light beam to be projected onto the holographic optical disk 100 upon recording information is a converging light beam. The following description assumes that the information light beam passes through the pinhole 105 when the diameter of the information light beam becomes the minimum, i.e., the beam waist, as shown in FIG. 4.

FIG. 6 is a graph for explaining a relation between intensity of the information light beam and a focus position of the information light beam. The information light beam passes through the pinhole 105 when the diameter of the information light beam is equal to the beam waist, so that the intensity of the information light beam detected by the light detector 212 attains a maximum value. Specifically, a voltage of an electrical signal generated by the information light beam in a beam position of the light detector 212 attains a maximum value. Thus, the position control unit 501 determines a specified focus position onto which the laser light beam is to be converged. The position control unit 501 transmits a command to the system controller 502 to move the holographic optical disk 100 or the objective lens 206, so that the information light beam is converged onto the specified focus position. In this manner, the position control unit 501 controls a focus position of the information light beam on the holographic optical disk 100 and positional deviation of a focus position in the radial direction.

The holographic optical disk 100 may tilt due to various reasons while the information light beam is passing through the pinholes 105. In case the holographic optical disk 100 tilts, the passage of the information light beam is affected due to the tilt and such non-normal information light beam, i.e., information light beam with positional deviation, may enter the light detector 212. The position control unit 501 acquires a degree of the tilt of the holographic optical disk 100 by detecting the positional deviation of the information light beam. The position control unit 501 then controls a position of the holographic optical disk 100, thereby correcting the tilt of the holographic optical disk 100. The correction of tilt of the holographic optical disk 100 can be performed by using other methods.

In the collinear system, only the reference light beam is projected onto the holographic optical disk 100 upon reproducing recorded information. Because the reference light beam is converged onto the holographic optical disk 100 in the same manner as the information light beam, i.e., the beam waist position of the reference light beam is the same as that of the information light beam. For this reason, the position control unit 501 performs the position control based on intensity of the reference light beam upon reproducing recorded information in the same manner as the position control unit 501 does based on intensity of the information light beam upon recording information.

In the collinear system or other systems, a reproduction light beam is generated to reproduce recorded information. The reproduction light beam corresponds to the information light beam projected onto the holographic optical disk 100 upon recording information. The position control unit 501 receives the reproduction light beam as an image, and adjusts a position between the holographic optical disk 100 and the laser light beam by using the image, so that it is possible to prevent image defocusing and deviation of a display position. With this configuration, it is possible to separately detect a focus position of a laser light beam in the holographic optical disk 100, a degree of tilt of the holographic optical disk 100, and a degree of deviation of the holographic optical disk 100 in the radical direction.

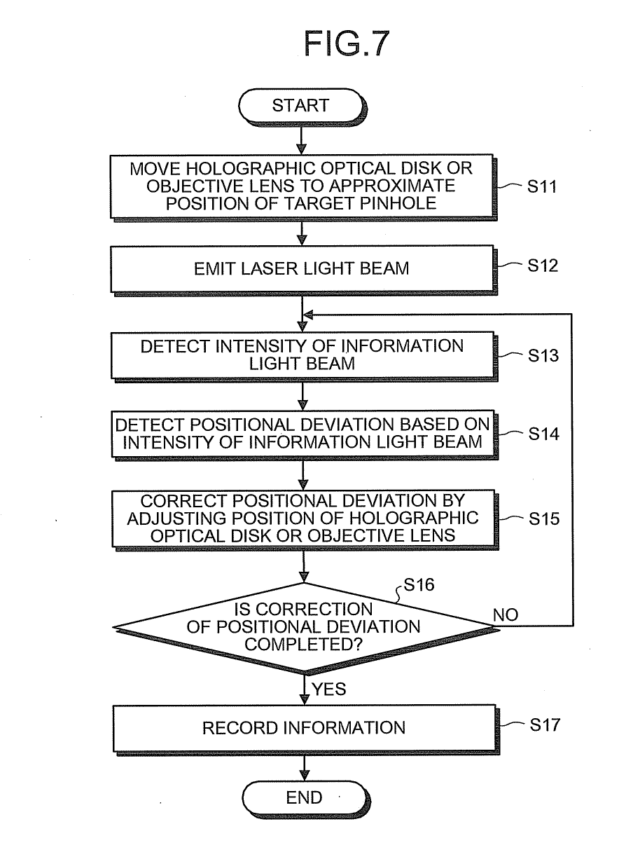

FIG. 7 is a flowchart of position control operation performed by the recording/reproducing apparatus 230 upon recording information. The position control unit 501 moves the holographic optical disk 100 or the objective lens 206 to an approximate position to project the information light beam through a target pinhole 105 (step S11). Specifically, the position control unit 501 sends a command to the system controller 502 to drive the actuator 205 or the actuator 207 to move the holographic optical disk 100 or the objective lens 206. The semiconductor laser 201 then emits a laser light beam (step S12).

The light detector 212 receives the information light beam that has passed through the pinhole 105. The position control unit 501 detects intensity of the information light beam received by the light detector 212 (step S13), and then detects positional deviation between the laser light beam and the holographic optical disk 100 by determining whether the detected intensity is a maximum value (step S14). Specifically, the position control unit 501 detects the positional deviation by determining whether a voltage generated by the information light beam is a maximum value.

The position control unit 501 performs correction corresponding to the detected positional deviation by adjusting a position of the holographic optical disk 100 or the objective lens 206, so that the intensity of the information light beam becomes a maximum value (step S15). The processes at steps S13 to S15 are repeated until the correction of the positional deviation is completed (step S16). When the correction of the positional deviation is completed, information (page data) is recorded in the hologram recording layer 102 (step S17). Thus, page data can be accurately recorded in the hologram recording layer 102 in a multiplexed manner.

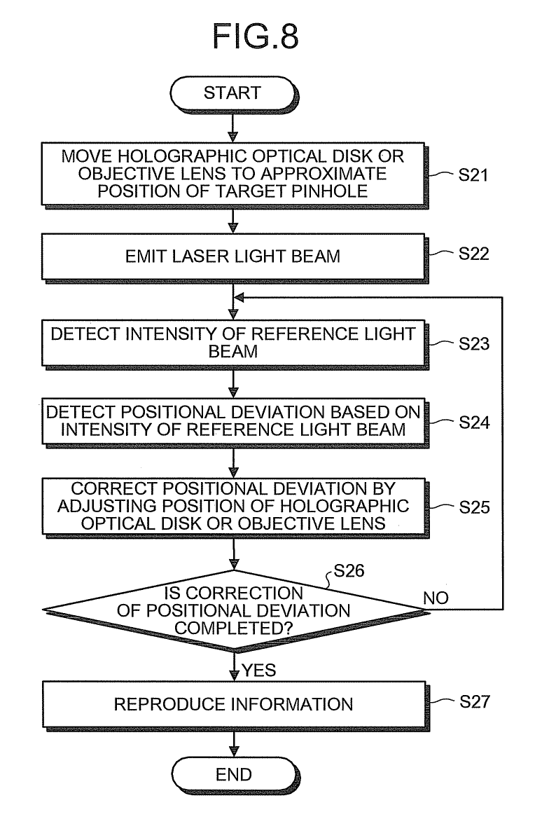

FIG. 8 is a flowchart of position control operation performed by the recording/reproducing apparatus 230 upon reproducing recorded information. The position control unit 501 moves the holographic optical disk 100 or the objective lens 206 to an approximate position to project the reference light beam through a target pinhole 105 (step S21). The semiconductor laser 201 then emits a laser light beam (the reference light beam) (step S22).

The light detector 212 receives the reference light beam. The position control unit 501 detects intensity of the reference light beam detected by the light detector 212 (step S23), and then detects positional deviation between the laser light beam and the holographic optical disk 100 by determining whether the detected intensity is a maximum value (step S24).

The position control unit 501 corrects the detected positional deviation by adjusting a position of the holographic optical disk 100 or the objective lens 206, so that the intensity of the reference light beam reaches a maximum value (step S25). The processes at steps S23 to S25 are repeated until the correction of the positional deviation is completed (step S26). When the correction of the positional deviation is completed, information (page data) is reproduced from the hologram recording layer 102 (step S27).

As described above, in the holographic optical disk 100, the thin film layer 104 with the pinholes 105 is laminated on an area corresponding to the hologram recording layer 102.

The pinholes 105 allow passage of the information light beam and the reference light beam. In the recording/reproducing apparatus 230, the position control unit 501 controls a relative position of a focus position of a laser light beam and the holographic optical disk 100 based on the intensity of the information light beam or the reference light beam passing through the pinhole 105 and received by the light detector 212. As a result, a relative position between a focus position of a laser light beam and the holographic optical disk 100 can be controlled as accurately, so that page data can be accurately recorded in the hologram recording layer 102 in a multiplexed manner.

Although the collinear system is employed as the optical system 200 of the recording/reproducing apparatus 230, other system, such as a double-beam system, can be employed.

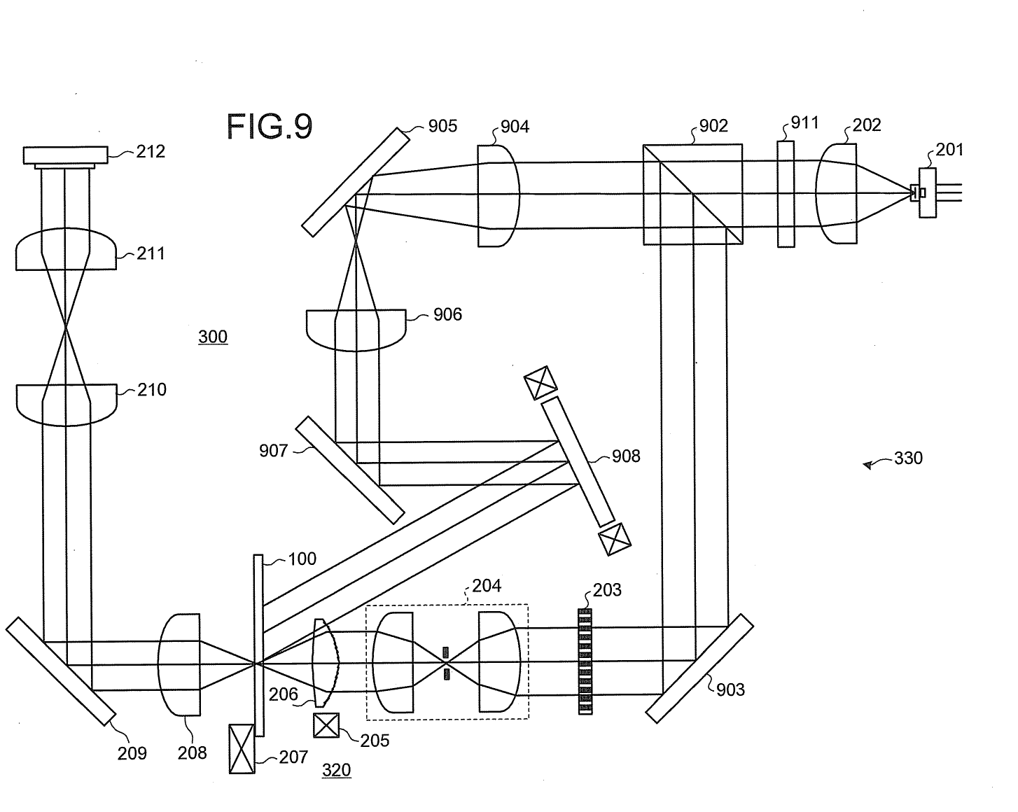

FIG. 9 is a schematic diagram of an optical system 300 and a portion of a servomechanism 320 of a recording/reproducing apparatus 330 according to a second embodiment of the present invention. The optical system 300 shown in FIG. 9 is a double-beam system. A laser light beam is emitted from the semiconductor laser 201, and then converted by the collimator lens 202 into a parallel light beam. The parallel laser light beam is projected through a half-wavelength plate 911, and is split into a reflected light beam and a transmitted light beam by a polarization beam splitter 902. The reflected light beam is reflected by a mirror 903, and is then subjected to the same processes as in the collinear system described above. Specifically, the reflected light beam enters the spatial light modulator 203, whereby the reflected light beam is converted into an information light beam. The information light beam is projected through the spatial filter 204, and is converged onto the holographic optical disk 100. On the other hand, the transmitted light beam is projected through an objective lens 904, a mirror 905, an objective lens 906, a mirror 907, and a mirror 908, and then is projected onto the holographic optical disk 100 as a reference light beam.

Because the information light beam and the reference light beam pass through the pinhole 105 as shown in FIG. 4 in the double-beam system, it is possible to control a relative position between a focus position of a laser light beam and the holographic optical disk 100 based on intensity of the information light beam or the reference light beam detected by the light detector 212.

In the recording/reproducing apparatuses 230, 330 according to the first and second embodiments, a relative position between a focus position of a laser light beam and the holographic optical disk 100 are controlled based on intensity of the information light beam. In a third embodiment of the present invention, however, the relative position between those two components is controlled based on intensity of servo light beams passing through the pinhole 105 in addition to the intensity of the information light beam.

The holographic optical disk 100 employed in the third embodiment has the same configuration as that in the first embodiment. A servomechanism 420 included in a recording/reproducing apparatus 430 according to the third embodiment has the same configuration as the servomechanism 220 in the recording/reproducing apparatus 230 of the first embodiment.

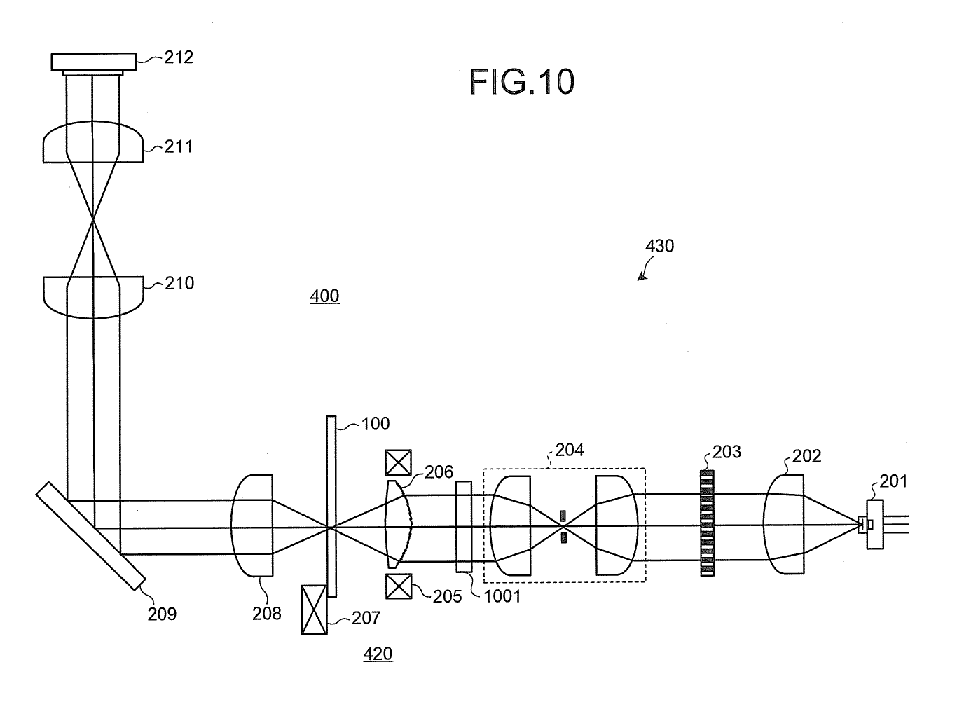

FIG. 10 is a schematic diagram of an optical system 400 of the recording/reproducing apparatus 430 according to the third embodiment. The optical system 400 has the same configuration as the optical system 200 shown in FIG. 3, except that a diffraction grating 1001 is arranged between the spatial filter 204 and the objective lens 206 in the optical system 400.

The spatial light modulator 203 causes certain pixel areas, other than pixel areas for generating the information light beam, to generate the servo light beams.

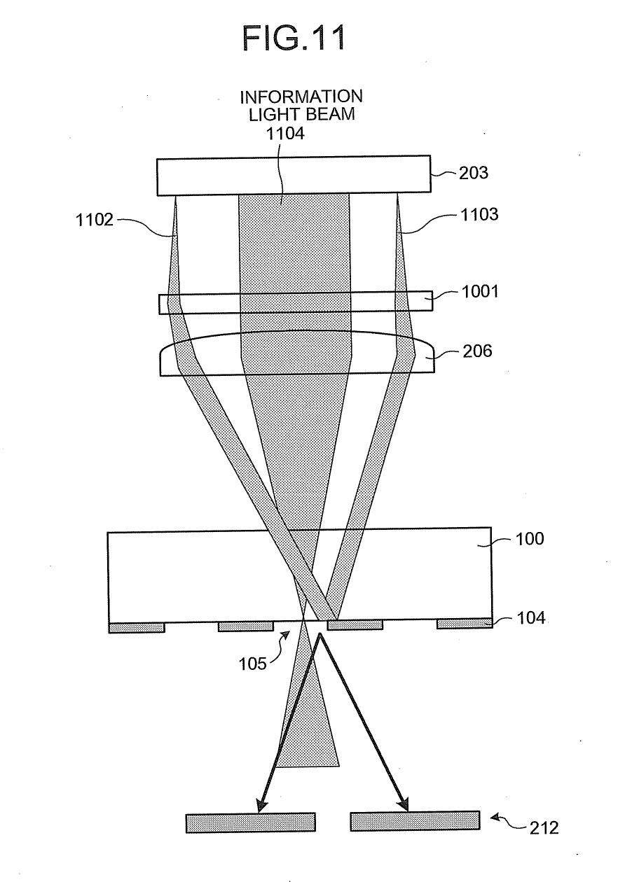

FIG. 11 is a schematic diagram of an information light beam 1104 and servo light beams 1102, 1103 that are passing through one of the pinholes 105. The information light beam 1104 (a light beam for recording information) and the servo light beams 1102, 1103 are projected onto the holographic optical disk 100 and pass through one of the pinholes 105. For convenience of explanation, the reference light beam and a part of the optical system are not shown.

A laser light beam having a larger diameter than that of a laser light beam required for generating the information light beam 1104 is projected through the spatial light modulator 203, so that the laser light beam is converted into the information light beam 1104 and the servo light beams 1102, 1103 by the spatial light modulator 203.

As described above, the spatial light modulator 203 causes certain pixel areas to generate the servo light beam. However, the servo light beams can be generated by preliminarily arranging a reflection plane for a reflection-type modulator, or a transmission plane for a transmission-type modulator on the output side of the spatial light modulator 203. Alternatively, the servo light beams can be generated by projecting a laser light beam through other optical path, rather than through the spatial light modulator 203.

Although a laser light beam having a wavelength different from that of the information light beam can be used as the servo light beam, it is preferable that the servo light beam has the same wavelength as that of the information light beam, which makes it easier to configure the optical system.

Although it is possible to use one servo light beam in the recording/reproducing apparatus, it is preferable that two or more servo light beams are projected symmetrically with respect to the information light beam. In the third embodiment, two servo light beams 1102, 1103 are generated by the spatial light modulator 203.

The servo light beams 1102, 1103 are projected trough the diffraction grating 1001 and the objective lens 206, and then enter the holographic optical disk 100. The servo light beams 1102, 1103 projected through the holographic optical disk 100 are received by the light detector 212. The information light beam 1104 is not affected by the diffraction grating 1001 upon projecting therethrough. The information light beam is converged by the objective lens 206 and projected through one of the pinholes 105. On the other hand, when the servo light beams 1102, 1103 are projected through the diffraction grating 1001, optical paths of the servo light beams 1102, 1103 are changed by the diffraction grating 1001. The servo light beams 1102, 1103 then pass through the objective lens 206, and enter the holographic optical disk 100. If the holographic optical disk 100 is arranged at an appropriate position such that the laser light beam is converged onto a specified focus position in the holographic optical disk 100, the central portion of each of the servo light beams 1102, 1103 is projected onto the circumference of the pinhole 105.

As shown in FIG. 11, the servo light beams 1102, 1103 are projected onto one position at different incidence angles. The servo light beams 1102, 1103 and the information light beam are received by the common light detector 212. Therefore, incidence angles of the servo light beams 1102, 1103 and a configuration of the optical system are defined such that the servo light beams 1102, 1103 do not enter the same position of the light detector 212 as the information light beam 1104 does. Specifically, the diffraction grating 1001 is arranged on the incidence side of the objective lens 206, so that incidence angles of the servo light beams 1102, 1103 are changed by the diffraction grating 1001, thereby preventing the servo light beams 1102, 1103 and the information light beam 1104 from entering the same position of the light detector 212. However, the diffraction grating 1001 can be arranged in a different position than that shown in FIG. 10, or it can be attached on a surface of the objective lens 206, if the servo light beams 1102, 1103 can be prevented from entering the same position as the information light beam does. Instead of using the diffraction grating 1001, different refractive indexes or curvatures can be applied to a central portion and a circumferential portion of a surface of the objective lens 206, thereby changing incidence angles of the servo light beams 1102, 1103.

Preferably, intensity of each of the servo light beams 1102, 1103 are lower than that of the information light beam 1104, but high enough to be detected by the light detector 212. Furthermore, it is preferable that each of the servo light beams 1102, 1103 is converted into an approximately parallel light beam after projecting through the objective lens 206, and enters the holographic optical disk 100. Diameters of the servo light beams 1102, 1103 are preferably equal to each other.

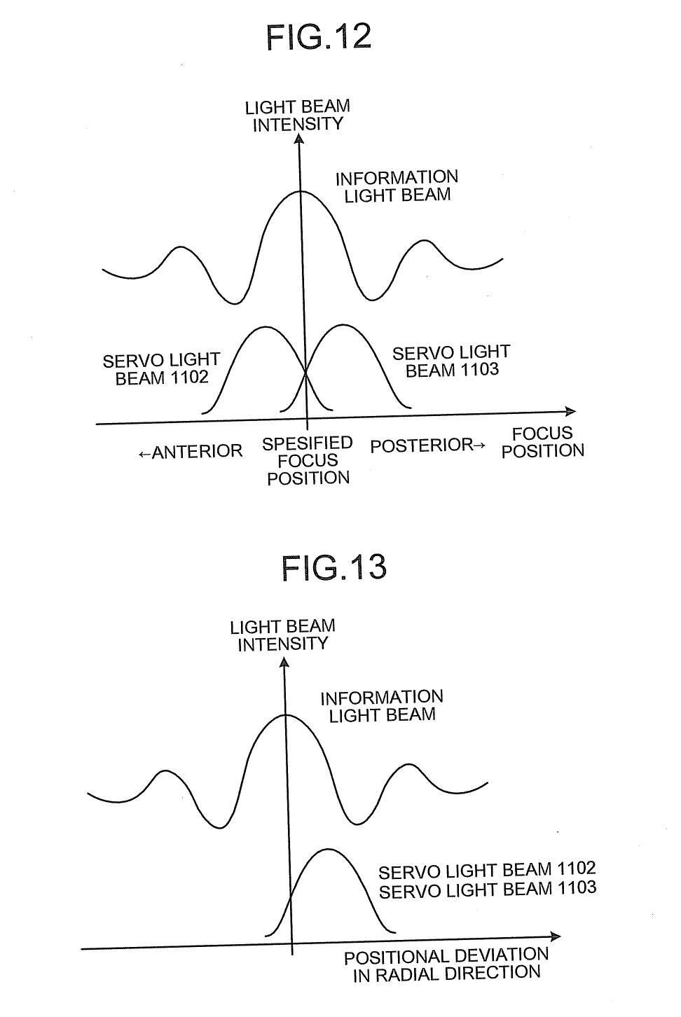

FIG. 12 is a graph for explaining changes of intensities of the servo light beams 1102, 1103 due to positional deviation of a focus position of the laser light beam in the holographic optical disk 100. When a laser light beam is focused onto an area anterior to the specified focus position, the intensity of the servo light beam 1102 detected by the light detector 212 becomes higher; because, a larger amount of the servo light beam 1102 passes through the pinhole 105. On the other hand, when a laser light beam is focused onto an area posterior to the specified focus position, the intensity of the servo light beam 1103 becomes higher; because, a larger amount of the servo light beam 1103 passes through the pinhole 105. Therefore, it is possible to determine whether the laser light beam is focused onto an area anterior or posterior to the specified focus position by detecting changes of intensities of the servo light beams 1102, 1103. In this manner, the position control unit 501 determines whether the current focus position is located anterior or posterior to the specified focus position, thereby determining a direction to which the holographic optical disk 100 or the objective lens 206 is to be moved for adjustment.

The position control unit 501 then performs the position control based on intensity of the information light beam 1104 in the manner as described in the first embodiment, and moves the objective lens 206 or the holographic optical disk 100 to that direction. As a result, the laser light beam is converged onto the specified focus position in the holographic optical disk 100.

FIG. 13 is a graph for explaining changes of intensities of the servo light beams 1102, 1103 due to positional deviation of a focus position of a laser light beam in the radial direction of the holographic optical disk 100. When a focus position of a laser light beam deviates from a specified focus position in the radial direction of the holographic optical disk 100, intensities of the servo light beams 1102, 1103 are changed in the same manner as shown in FIG. 13. The position control unit 501 determines whether a current focus position deviates from the specified focus position to the right side or to the left side. The position control unit 501 then performs the position control based on the intensity of the information light beam 1104 in the manner as described in the first embodiment, thereby adjusting a position of the holographic optical disk 100 in the radial direction.

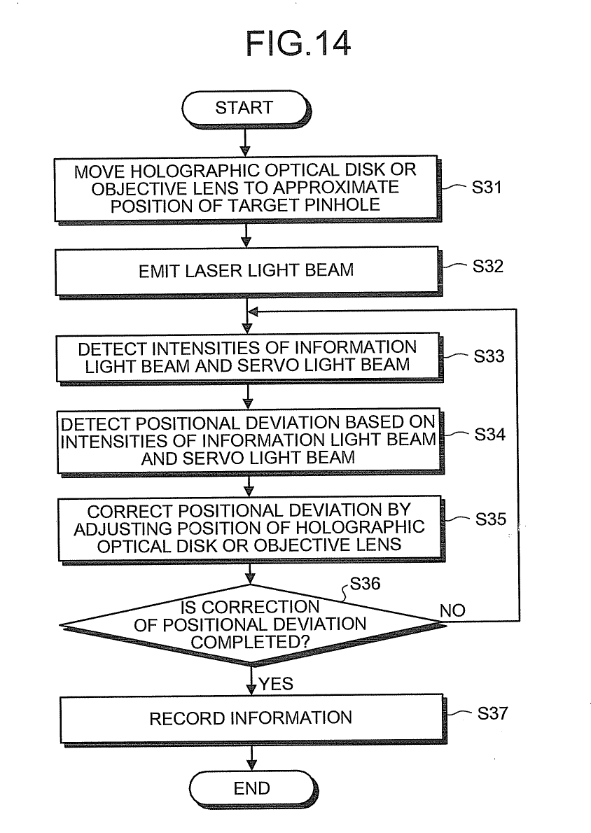

FIG. 14 is a flowchart of position control operation performed by the recording/reproducing apparatus 430 upon recording information. The position control unit 501 moves the holographic optical disk 100 or the objective lens 206 to an approximate position to project the information light beam 1104 through a target pinhole 105 (step S31). The semiconductor laser 201 then emits a laser light beam (step S32).

The light detector 212 receives the information light beam 1104 and the servo light beams 1102, 1103. The position control unit 501 detects intensities of the information light beam 1104 and the servo light beams 1102, 1103 detected by the light detector 212 (step S33), and then detects positional deviation of a focus position of the laser light beam based on the intensities of the information light beam 1104 and the servo light beams 1102, 1103 (step S34). Specifically, as described above, the position control unit 501 determines whether a current focus position is located anterior or posterior to the specified focus position, or a current focus position deviates from the specified focus position in the radial direction based on the intensities of the servo light beams 1102, 1103.

The position control unit 501 then determines a direction to which the holographic optical disk 100 or the objective lens 206 is to be moved for adjustment based on the detected positional deviation of a current focus position. The position control unit 501 corrects the detected positional deviation by adjusting a position of the holographic optical disk 100 or the objective lens 206 to that direction based on the intensity of the information light beam in the manner as described in the first embodiment (step S35). The processes at steps 33 to 35 are repeated until the correction of the positional deviation is completed (step S36). When the correction of the positional deviation is completed, information (page data) is recorded in the hologram recording layer 102 (step S37). Thus, page data can be accurately recorded in the hologram recording layer 102 in a multiplexed manner.

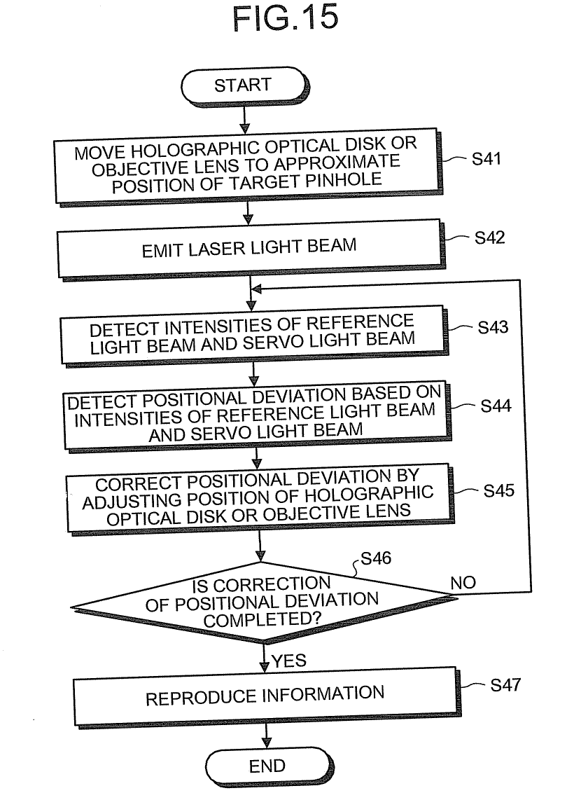

FIG. 15 is a flowchart of position control operation performed by the recording/reproducing apparatus 430 upon reproducing information. The position control unit 501 moves the holographic optical disk 100 or the objective lens 206 to an approximate position to project the reference light beam through a target pinhole 105 (step S41). The semiconductor laser 201 then emits a laser light beam (step S42).

The light detector 212 receives the reference light beam and the servo light beams 1102, 1103 when the semiconductor laser 201 emits the laser light beam. The position control unit 501 then detects intensities of the reference light beam and the servo light beams 1102, 1103 detected by the light detector 212 (step S43), and then detects positional deviation of a focus position of the laser light beam based on the intensities of the reference light beam and the servo light beams 1102, 1103 (step S44). Specific operation for detecting the positional deviation upon reproducing information is performed in the same manner as that upon recording information.

The position control unit 501 then determines a direction to which the holographic optical disk 100 or the objective lens 206 is to be moved for adjustment based on the detected positional deviation of a current focus position. The position control unit 501 corrects the detected positional deviation by adjusting a position of the holographic optical disk 100 or the objective lens 206 to that direction based on the intensity of the information light beam in the manner as described in the first embodiment, (step S45). The processes at steps S43 to S45 are repeated until the correction of the positional deviation is completed (step S46). When the correction of the positional deviation is completed, information (page data) is reproduced from the hologram recording layer 102 (step S47).

In the recording/reproducing apparatus 430, as described above, a focus position of a laser light beam is controlled based on intensities of the servo light beams 1102, 1103 in addition to intensities of the information light beam 1104 and the reference light beam. In this manner, a relative position between a focus position of a laser light beam and the holographic optical disk 100 is controlled as appropriate, so that page data can be accurately recorded in the hologram recording layer 102 in a multiplexed manner.

Although two servo light beams 1102, 1103 are used for the position control, the position control can be performed by using three servo light beams.

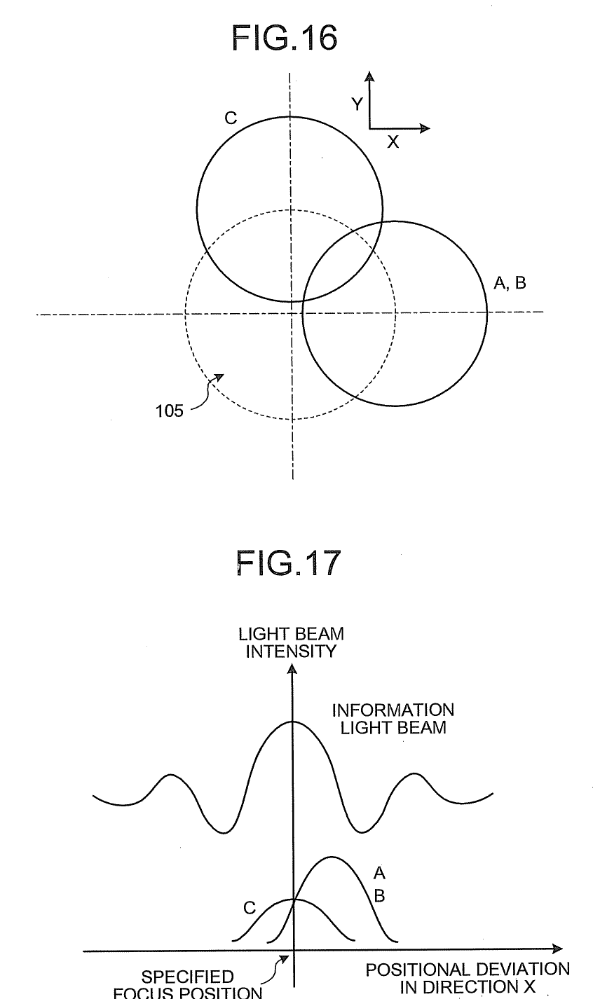

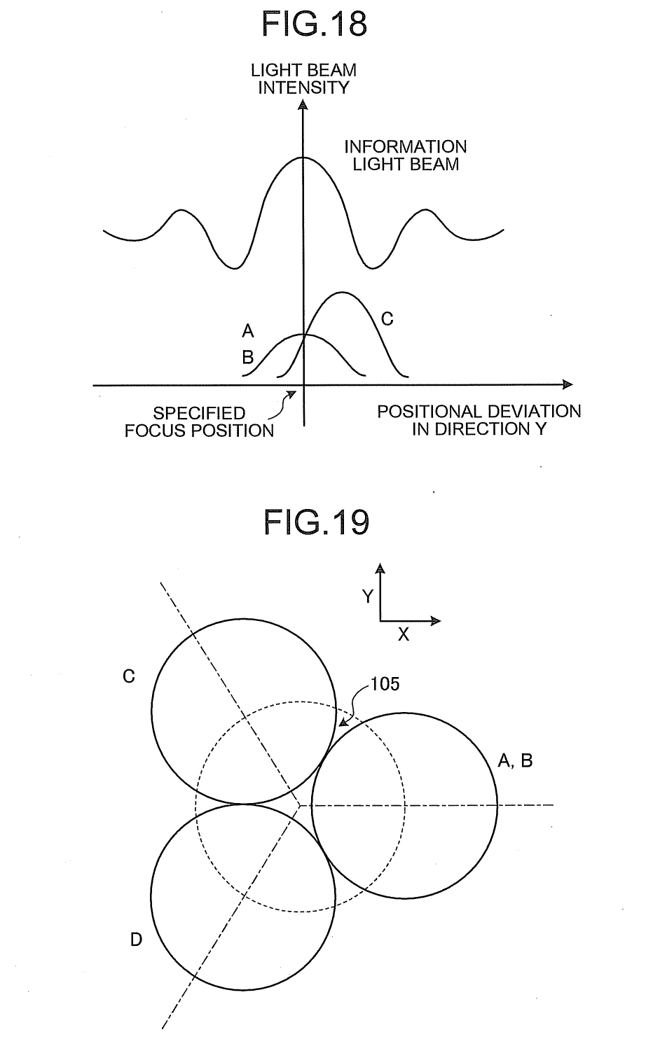

FIG. 16 is a schematic diagram for explaining positions of three servo light beams A, B, C projected onto the pinhole 105. The servo light beams A, B are projected onto one position on the circumference of the pinhole 105, and the servo light beam C is projected onto a different position on the circumference of the pinhole 105. FIG. 17 is a graph for explaining changes of intensities of the servo light beams A, B, C due to positional deviation of the holographic optical disk 100 in a direction X shown in FIG. 16. FIG. 18 is a graph for explaining changes of intensities of the servo light beams A, B, C due to positional deviation of the holographic optical disk 100 in a direction Y shown in FIG. 16.

Because the servo light beams A, B are projected on one position, the intensities of the servo light beams A, B are higher than that of the servo light beam C. Such a difference in the intensities between the servo light beams A, B and the servo light beam C can be used to detect positional deviation of a focus position of a laser light beam in the directions X and Y. In this manner, the position control unit 501 detects positional deviation of a focus position, and determines a direction to which the holographic optical disk 100 or the objective lens 206 is to be moved for adjustment. The position control unit 501 then performs the position control based on the intensity of the information light beam in the manner as described in the first embodiment.

FIG. 19 is a schematic diagram for explaining positions of four servo light beams A, B, C, D projected onto the pinhole 105. The servo light beams A, B are projected onto one position on the circumference of the pinhole 105, and each of the servo light beams C, D is projected onto a different position on the circumference of the pinhole 105. The focus positions of the servo light beams A, B, the servo light beam C, and the servo light beam D are spaced from one another by 120 degrees on the circumference of the pinhole 105.

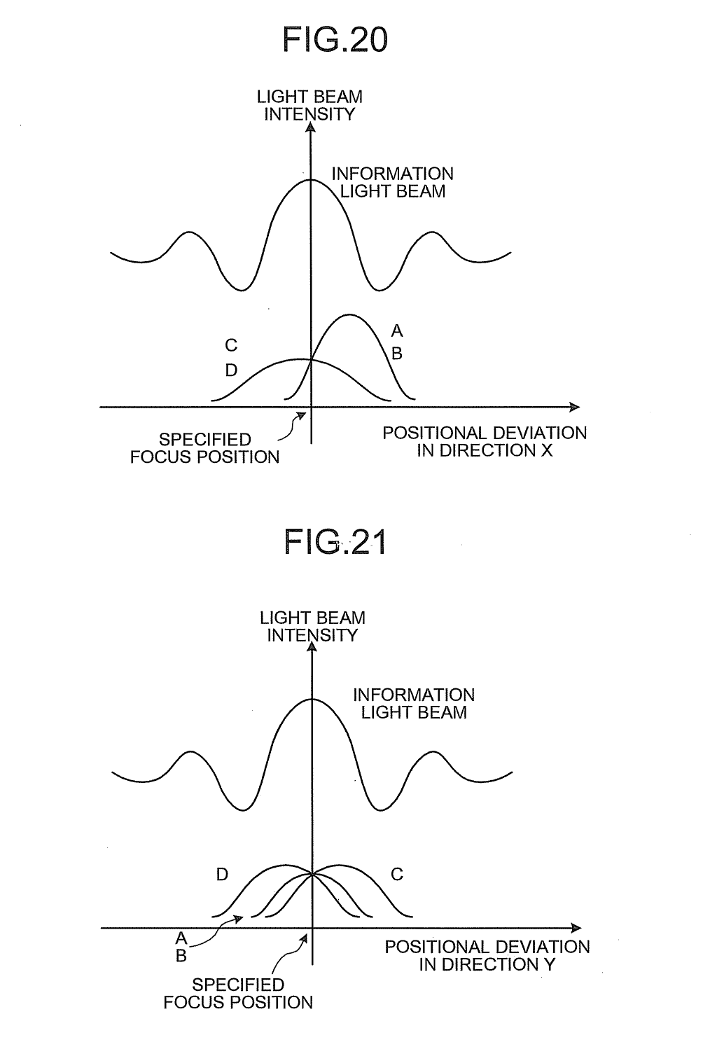

FIG. 20 is a graph for explaining changes of intensities of the servo light beams A, B, C, D due to positional deviation of the holographic optical disk 100 in a direction X shown in FIG. 19. FIG. 21 is a graph for explaining changes of intensities of the servo light beams A, B, C, D due to positional deviation of the holographic optical disk 100 in a direction Y shown in FIG. 19. The intensities of the servo light beams A, B are changed in the same manner. The intensities of the servo light beams A, B, the servo light beam C, and the servo light beam D are changed in a different manner depending on positional deviation of the focus position.

A specified focus position is determined based on the intensities of the servo light beams A, B, the servo light beam C, and the servo light beam D, i.e., when the intensities of the servo light beams A, B, the servo light beam C, and the servo light beam D become the same value, it is determined that a laser light beam is converged onto a specified focus position. In this manner, it is possible to detect positional deviation of a focus position of a laser light beam. The position control unit 501 determines a direction to which the holographic optical disk 100 or the objective lens 206 is to be moved for adjustment based on the detected positional deviation. The position control unit 501 then moves the holographic optical disk 100 or the objective lens 206 to that direction, so that a laser light beam is converged onto the specified focus position.

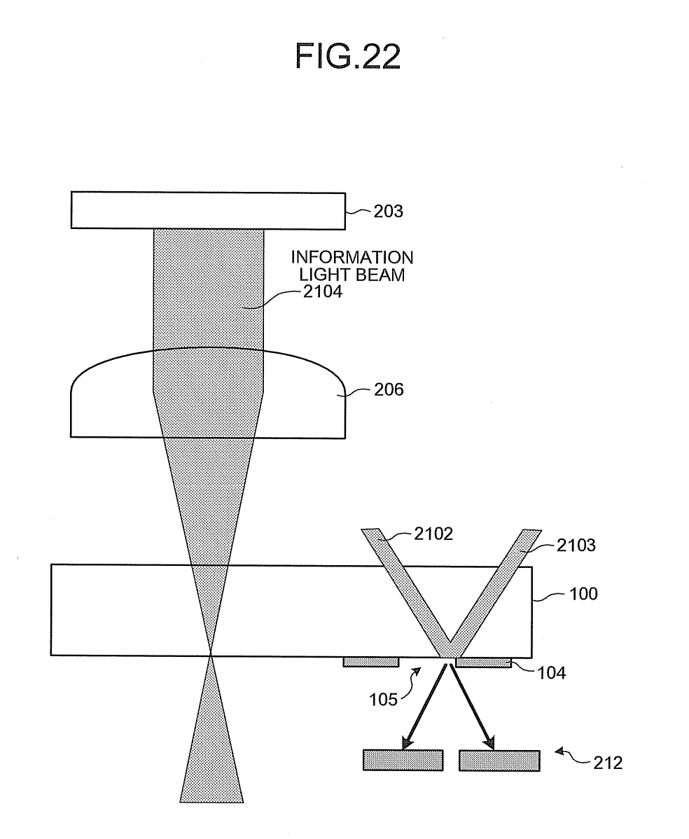

FIG. 22 is a schematic diagram of servo light beams 2102, 2103 passing through the pinhole 105. For convenience of explanation, the reference light beam and a part of the optical system are not shown.

In the recording/reproducing apparatus 430, the servo light beam, the information light beam, and the reference light beam are projected onto one pinhole 105. In a fourth embodiment of the present invention, however, an information light beam 2104 and the reference light beam are projected onto one pinhole 105, and the servo light beams 2102, 2103 are projected onto a different pinhole 105.

An optical system of a recording/reproducing apparatus according to the fourth embodiment has the same configuration as that of the recording/reproducing apparatus 430, except that the optical system in the fourth embodiment includes two light detectors 212; one for receiving the information light beam 2104 and the reference light beam, and the other for receiving the servo light beams 2102, 2103.

A servomechanism of the recording/reproducing apparatus according to the fourth embodiment has the same configuration as those in the first and second embodiments.

The servo light beams 2102, 2103 are projected onto one pinhole 105. Specifically, the servo light beams 2102, 2103 are projected onto one of the pinholes 105 that is arranged on the circumferential portion of the holographic optical disk 100. The position control is performed in the same manner as described in the third embodiment.

In the fourth embodiment, as described above, the servo light beams 2102, 2103 are projected onto a different pinhole 105, and the position control is performed based on the intensities of the servo light beams 2102, 2103. Thus, the diameter of the pinhole 105 need not be larger than the beam waist of the information light beam 2104. Furthermore, because the servo light beams 1102, 1103 and the information light beam 2104 can be projected by using different laser light beams and optical systems, it is possible to reduce design complexity and the number of components to be used. Thus, a relative position between a focus position of a laser light beam and the holographic optical disk 100 is controlled as appropriate, so that page data can be accurately recorded in the hologram recording layer 102 in a multiplexed manner.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical information recording medium comprising:
a substrate;
a recording layer that is laminated on a first surface of the substrate, and in which information can be recorded as a hologram by using a phenomenon of interference between an information light beam and a reference light beam; and
a thin film layer that is laminated on a second surface of the substrate, and that includes a first opening,
wherein the first opening is arranged in a position onto which the information light beam and the reference light beam are projected, and allows passage of the information light beam and the reference light beam.

2. The recording medium according to claim 1, wherein the first opening allows passage of a servo light beam.

3. The recording medium according to claim 1, wherein the first opening allows passage of a plurality of servo light beams.

4. The recording medium according to claim 3, wherein the thin film layer includes a second opening which is arranged in a position different from a position onto which the information light beam and the reference light beam are projected, and
the second opening allows passage of the servo light beams.

5. An apparatus for recording and reproducing optical information in an optical information recording medium, the apparatus comprising:
a light source that emits a light beam;
a spatial light modulator that receives the light beam and converts the light beam into an information light beam;
a focusing unit that focuses the information light beam and a reference light beam onto the optical information recording medium,
the optical information recording medium including
a substrate;
a recording layer that is laminated on a first surface of the substrate, and in which information can be recorded as a hologram by using a phenomenon of interference between the information light beam and the reference light beam; and
a thin film layer that is laminated on a second surface of the substrate, and that includes a first opening,
wherein the first opening is arranged in a position onto which the information light beam and the reference light beam are projected, and allows passage of the information light beam and the reference light beam;
a detector that detects the information light beam and the reference light beam that have passed through the first opening in the thin film layer;
a moving unit configured to move the optical information recording medium and the focusing unit relative to each other; and
a position control unit that controls the moving unit to control a relative position of a focus position of the information light beam and the reference light beam and the optical information recording medium based on intensities of the information light beam and the reference light beam detected by the detector.

6. The apparatus according to claim 5, wherein
the position control unit controls the moving unit to control the relative position based on a specified position upon recording and reproducing optical information, wherein the intensity of the information light beam detected by the detector becomes maximum when the focus position and the optical information recording medium are located at the specified position.

7. The apparatus according to claim 5, wherein
the first opening allows passage of a plurality of servo light beams,
the detector detects the servo light beams that have passed through the first opening, and
the position control unit controls the moving unit to control the relative position based on intensities of the servo light beams detected by the detector.

8. The apparatus according to claim 7, wherein
the position control unit calculates a directional deviation of the focus position and the optical information recording medium from a specified position based on the intensities of the servo light beams, and controls the relative position based on the directional deviation.

9. The apparatus according to claim 7, wherein
the focusing unit projects the servo light beams onto a circumference of the first opening at equal center angle intervals, and
the position control unit controls the moving unit to control the relative position based on a specified position upon recording and reproducing optical information, wherein the servo light beams detected by the detector have same intensities when the focus position and the optical information recording medium are located at the specified position.

10. The apparatus according to claim 5, wherein
the thin film layer includes a second opening which is arranged in a position different from a position onto which the information light beam and the reference light beam are projected and allows passage of a plurality of servo light beams, and
the position control unit controls the moving unit to control the relative position based on intensities of the servo light beams detected by the detector.

11. The apparatus according to claim 10, wherein
the position control unit detects directional deviation of the focus position and the optical information recording medium from a specified position based on the intensities of the servo light beams, and controls the moving unit to control the relative position based on the directional deviation.

12. The apparatus according to claim 10, wherein
the position control unit controls the moving unit to control the relative position based on a specified position upon recording and reproducing optical information, wherein the servo light beams detected by the detector have same intensities when the focus position and the optical information recording medium are located at the specified position.

13. A method of positioning realized in an apparatus for recording and reproducing optical information in an optical information recording medium, the method comprising:
emitting a light beam;
converting the light beam into an information light beam;
focusing the information light beam and a reference light beam onto the optical information recording medium, the optical information recording medium including
a substrate;
a recording layer is laminated on a first surface of the substrate, and in which information can be recorded as a hologram by using a phenomenon of interference between the information light beam and the reference light beam; and
a thin film layer that is laminated on a second surface of the substrate, and that includes a first opening,
wherein the first opening is arranged in a position onto which the information light beam and the reference light beam are projected, and allows passage of the information light beam and the reference light beam;
detecting the information light beam and the reference light beam that have passed through the first opening in the thin film layer; and
adjusting a relative position of a focus position of the information light beam and the reference light beam and the optical information recording medium based on intensities of the information light beam and the reference light beam detected at the detecting.
